(19) United States
(12) Patent Application Publication
(10) Pub. No.: US 2026/0162344 A1
(43) Pub. Date: Jun. 11, 2026

(54) 3D ASSET SEARCH METHOD AND COMPUTING DEVICE FOR PERFORMING THE SAME

(71) Applicant: University-Industry Cooperation Group of Kyung Hee University, Gyeonggi-do (KR)

(72) Inventors: OH BYUNG KWON, Seoul (KR); SANG JI KWON, Gyeonggi-do (KR); JI HYE HUH, Seoul (KR); EUN SEO LEE, Seoul (KR)

(21) Appl. No.: 19/237,383

(22) Filed: Jun. 13, 2025

(30) Foreign Application Priority Data
Dec. 11, 2024 (KR) 10-2024-0184219

(51) Int. Cl. G06T 13/40; G06N 20/00; G06T 17/00; G06V 20/70; H04L 51/02

(52) U.S. Cl. CPC G06T 13/40; G06N 20/00; G06T 17/00; G06V 20/70; H04L 51/02

(57) ABSTRACT

A 3D asset search method is performed by a computing device including one or more processors, and a memory configured to store one or more programs executed by the one or more processors. The method includes receiving a 3D asset and a 3D asset registration request including meta information about the 3D asset, checking whether an emotion value for the 3D asset is included in the meta information, and when the emotion value for the 3D asset is not included in the meta information, imputing the emotion value for the 3D asset based on at least one machine-learning model.

### CROSS REFERENCE TO RELATED APPLICATION AND CLAIM OF PRIORITY

This application claims the benefit under 35 USC § 119 of Korean Patent Application No. 10-2024-0184219, filed on Dec. 11, 2024, in the Korean Intellectual Property Office, the entire disclosure of which is incorporated herein by reference for all purposes.

### BACKGROUND

### 1. Field

The following description relates to a 3D asset search technology.

### 2. Description of Related Art

The data quality is an important factor for the quality of a data-based service or a machine-learning-based service and for a user to accept the same. One of factors for reducing data quality is the existence of missing data, and the missing data may degrade the reliability of data, increase the ambiguity in data analysis, and deteriorate the accuracy of statistical estimation to lead to wrong conclusion. However, it is common that missing values exist due to various causes such as errors, imperfect responses, system errors, costs, and the like in an actual data collection process. Accordingly, replacing such missing values is essential for maintaining the accuracy and reliability of data analysis.

Meanwhile, in case of a 3D asset dataset-based service, emotion-based search or recommendation is necessary. A 3D asset means a pre-worked object to be used for producing a 3D image. 3D assets are characterized by being emotionally consumed by young consumers in animations, games, emoticons, or the like. However, 3D assets are produced by various producers and uploaded, and thus it is difficult to expect that emotion values are written to all pieces of meta information about the 3D assets. Accordingly, solutions are required to be capable of searching for and recommending a 3D asset based on emotion.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide a 3D asset search method by which a 3D asset may be searched for and recommended based on emotion, and a computing device for performing the same.

In one general aspect, there is provided a method performed by a computing device including one or more processors, and a memory configured to store one or more programs executed by the one or more processors, the method including: receiving a 3D asset and a 3D asset registration request including meta information about the 3D asset; checking whether an emotion value for the 3D asset is included in the meta information; and imputing the emotion value for the 3D asset based on at least one machine-learning model when the emotion value for the 3D asset is not included in the meta information.

The imputing of the emotion value may include inputting an image of the 3D asset and description text for the 3D asset to the machine-learning model and training the machine-learning model to output an emotion value of the 3D asset.

The training of the machine-learning model may include: causing the machine-learning model to extract image embedding from the image of the 3D asset; causing the machine-learning model to extract text embedding from the description text; causing the machine-learning model to merge the image embedding and the text embedding to generate merged embedding; and causing the machine-learning model to output the emotion value of the 3D asset based on the merged embedding.

The imputing of the emotion value may include: inputting the image of the 3D asset to a first machine-learning model to generate description text for describing the 3D asset; combining the generated description text and description text included in the meta information to generate enhanced description text; and inputting the image of the 3D asset and the enhanced description text to a second machine-learning model and causing the emotion value for the 3D asset to be output.

The causing of the emotion value for the 3D asset to be output may include: causing the second machine-learning model to extract image embedding from the image of the 3D asset; causing the second machine-learning model to extract text embedding from the enhanced description text; causing the second machine-learning model to merge the image embedding and the text embedding to generate merged embedding; and causing the second machine-learning model to output the emotion value for the 3D asset based on the merged embedding.

The imputing of the emotion value may include: analyzing physical characteristics including at least one of a shape, a size, texture, or a color of the 3D asset; and inputting information about the at least one physical characteristic of the 3D asset to the second machine-learning model to cause the emotion value for the 3D asset to be output.

The method may further include: analyzing emotion desired by a user in a search query of the user; and extracting, from registered 3D assets, a 3D asset with an emotion value corresponding to the emotion desired by the user to provide the 3D asset to the user.

The method may further include recommending a 3D asset with an emotion value suitable to the user based on at least one of user information about a user who performs chat with an artificial intelligence (AI) chatbot or information acquired through the chat with the user.

The recommending of the 3D asset may include: identifying cultural background of an area to which the user belongs based on at least one of the user information or the information acquired through the chat with the user; and recommending to the user the 3D asset with an emotion value suitable for the user in consideration of the cultural background of the user.

In another general aspect, there is provided a computing device including: one or more processors; a memory; and one or more programs, wherein the one or more programs are stored in the memory and executed by the one or more processors, and wherein the one or more programs include: an instruction for receiving a 3D asset and a 3D asset registration request including meta information about the 3D asset; an instruction for checking whether an emotion value for the 3D asset is included in the meta information; and an instruction for imputing the emotion value for the 3D asset based on at least one machine-learning model when the emotion value for the 3D asset is not included in the meta information.

The instruction for imputing the emotion value may include: an instruction for inputting an image of the 3D asset and description text for the 3D asset to the machine-learning model and training the machine-learning model to output an emotion value of the 3D asset.

The instruction for imputing the emotion value may include: an instruction for inputting an image of the 3D asset to a first machine-learning model to generate description text for describing the 3D asset; an instruction for combining the generated description text and description text included in the meta information to generate enhanced description text; and an instruction for inputting the image of the 3D asset and the enhanced description text to a second machine-learning model and causing an emotion value for the 3D asset to be output.

The instruction for imputing the emotion value may include: an instruction for analyzing physical characteristics including at least one of a shape, a size, texture, or a color of the 3D asset; and an instruction for inputting information about the at least one physical characteristic of the 3D asset to a machine-learning model to cause an emotion value for the 3D asset to be output.

The instruction for imputing the emotion value may include: an instruction for inputting an image of the 3D asset and description text for the 3D asset to a first machine-learning model to output a first emotion value for the 3D asset; an instruction for inputting information about physical characteristics of the 3D asset to a second machine-learning model to cause a second emotion value for the 3D asset to be output; and an instruction for outputting a final emotion value for the 3D asset based on the first emotion value and the second emotion value.

The one or more programs may further include: an instruction for analyzing emotion desired by a user in a search query of the user; and an instruction for extracting, from registered 3D assets, a 3D asset with an emotion value corresponding to the emotion desired by the user to provide the 3D asset to the user.

The one or more programs may further include: an instruction for recommending a 3D asset with an emotion value suitable to a user, who performs chat with an AI chatbot, based on at least one of user information about the user or information acquired through the chat with the user.

The instruction for recommending the 3D asset may include: an instruction for identifying cultural background of an area to which a user belongs based on at least one of user information or information acquired through chat with the user; and an instruction for recommending to the user a 3D asset with an emotion value suitable for the user in consideration of the cultural background of the user.

In still another general aspect, there is provided a computer program stored in a non-transitory computer readable storage medium, the computer program including one or more instructions, wherein, when executed by a computing device including one or more processors, the instructions cause the computing device to: receive a 3D asset and a 3D asset registration request including meta information about the 3D asset; determine whether an emotion value for the 3D asset is included in the meta information; and impute the emotion value for the 3D asset based on at least one machine-learning model when the emotion value for the 3D asset is not included in the meta information.

Other features and aspects will be apparent from the following detailed description, the drawings, and the claims.

### BRIEF DESCRIPTION OF THE DRAWINGS

FIG. 1 shows the configuration of a 3D asset search system according to an embodiment of the present disclosure.

FIG. 2 is a block diagram illustrating the configuration of a service server according to an embodiment of the present disclosure.

FIG. 3 shows an emotion value imputation module for imputing emotion values according a first embodiment of the present disclosure.

FIG. 4 shows an emotion value imputation module for imputing an emotion value according a second embodiment of the present disclosure.

FIG. 5 shows an emotion value imputation module for imputing an emotion value according a third embodiment of the present disclosure.

FIG. 6 shows an emotion value imputation module for imputing an emotion value according a fourth embodiment of the present disclosure.

FIG. 7 shows a flowchart for explaining a 3D asset search method according to an embodiment of the present disclosure.

FIG. 8 is a block diagram illustratively describing a computing environment including a computing device suitable for being used in example embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, specific embodiments of the present disclosure will be described with reference to the accompanying drawings. The following detailed description is provided to aid in a comprehensive understanding of a method, a device and/or a system described in the present specification. However, the detailed description is only for illustrative purpose and the present disclosure is not limited thereto.

In describing the embodiments of the present disclosure, when it is determined that a detailed description of known technology related to the present disclosure may unnecessarily obscure the gist of the present disclosure, the detailed description thereof will be omitted. In addition, terms to be described later are terms defined in consideration of functions in the present disclosure, which may vary depending on intention or custom of a user or operator. Therefore, the definition of these terms should be made based on the contents throughout this specification. The terms used in the detailed description are only for describing the embodiments of the present disclosure and should not be used in a limiting sense. Unless expressly used otherwise, a singular form includes a plural form. In this description, expressions such as “including” or “comprising” are intended to indicate any property, number, step, element, and some or combinations thereof, and such expressions should not be interpreted to exclude the presence or possibility of one or more other properties, numbers, steps, elements other than those described, and some or combinations thereof.

Further, terms such as first and second may be used to describe various components, but the components should not be limited by the terms. The terms may be used for the purpose of distinguishing one component from other components. For example, a first component may be referred to as a second component without departing from the scope of the present disclosure, and similarly, the second component may also be referred to as the first component.

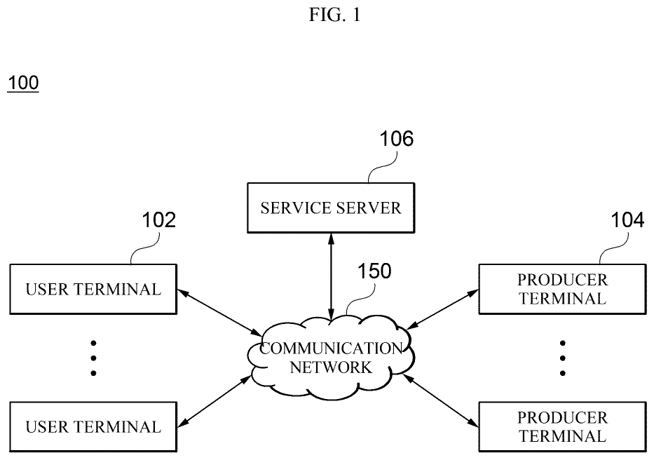

FIG. 1 shows the configuration of a 3D asset search system according to an embodiment of the present disclosure.

Referring to FIG. 1, the 3D asset search system 100 may include a user terminal 102, a producer terminal 104, and a service server 106. The user terminal 102 and the producer terminal 104 are communicatively connected to the service server 106 via a communication network 150.

The communication network 150 may include the Internet, one or more local area networks, wide area networks, a cellular network, a mobile network, various other types of networks, or a combination of these networks.

The user terminal 102 may make a connection to the service server 106 to search for a 3D asset required by a user. The user terminal 102 may include various electronic devices that may communicate with the service server and include smart phones, tablet PCs, wearable apparatuses, laptop PCs, desktop PCs, or the like. The user terminal 102 may transmit, to the service server 106, user information (e.g., gender, age, residence area, country, or the like) to register as a member. The user may perform chat with an artificial intelligence (AI) chatbot provided by the service server 106 via the user terminal 102.

The producer terminal 104 may be a terminal of a producer who produces 3D assets. The producer terminal 104 may upload and register the produced 3D assets to the service server 106. Here, emotion values of the 3D assets may be included in meta information about the 3D assets in dependence of the producer.

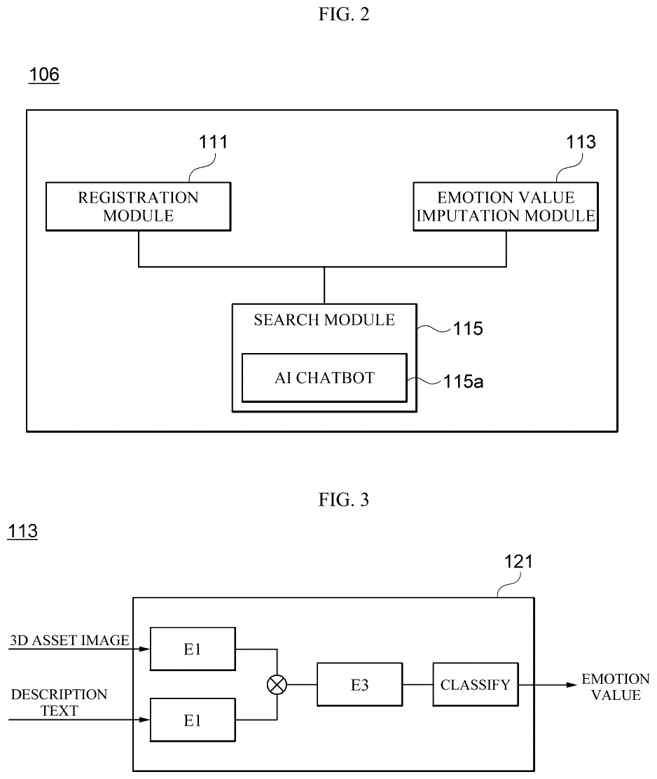

The service server 106 may be a computing device for providing a search service for the 3D assets. In addition, the service server 106 may also provide a recommendation service for the 3D assets. FIG. 2 is a block diagram showing the configuration of the service server 106 according to an embodiment of the present disclosure. Referring to FIG. 2, the service server 106 may include a registration module 111, an emotion value imputation module 113, and a search module 115.

The registration module 111 may perform user registration and 3D asset registration. The registration module 111 may receive a user registration request including user information from each user terminal 102, and register the user as a member in response to the received user registration request. The registration module 111 may receive, from each producer terminal 104, a 3D asset registration request including 3D assets and pieces of meta information about the 3D assets, and register the 3D assets in response to the received 3D asset registration request. Here, the meta information may include producer information about the 3D assets, production date and time, and description text for the 3D assets.

The emotion value imputation module 113 may determine whether emotion values (emotion values for the 3D assets) are included in the pieces of meta information about the 3D assets registered to the service server 106. Namely, the emotion value imputation module 113 may determine whether the emotion values exist as missing values in the pieces of meta information about the 3D assets. The emotion value imputation module 113 may impute the emotion values when the emotion values are not included in the pieces of meta information about the 3D assets. Here, the imputation means substituting the missing values. To this end, the emotion value imputation module 113 may include one or more machine-learning models.

### First Embodiment

FIG. 3 shows the emotion value imputation module 113 for imputing an emotion value according a first embodiment of the present disclosure.

Referring to FIG. 3, the emotion value imputation module 113 may include a machine-learning model 121. The machine-learning model 121 may be a multimodal-based model. In an embodiment, the machine-learning model 121 may be VisualBERT, but is not limited thereto. In this case, pre-trained VisualBERT may be fine-tuned to classify an emotion value of a 3D asset.

The machine-learning model 121 may receive an image of and description text for a 3D asset. The 3D asset image may be a 2D image or 3D image. The machine-learning model 121 may extract image embedding E1 from the 3D asset image, and text embedding E2 from the description text. The machine-learning model 121 may merge the image embedding E1 and the text embedding E2 to generate merged embedding E3. The machine-learning model 121 may be trained to classify an emotion value for the 3D asset based on the merged embedding E3. The emotion value imputation module 113 may impart the emotion value output by the machine-learning model 121 to the 3D asset.

### Second Embodiment

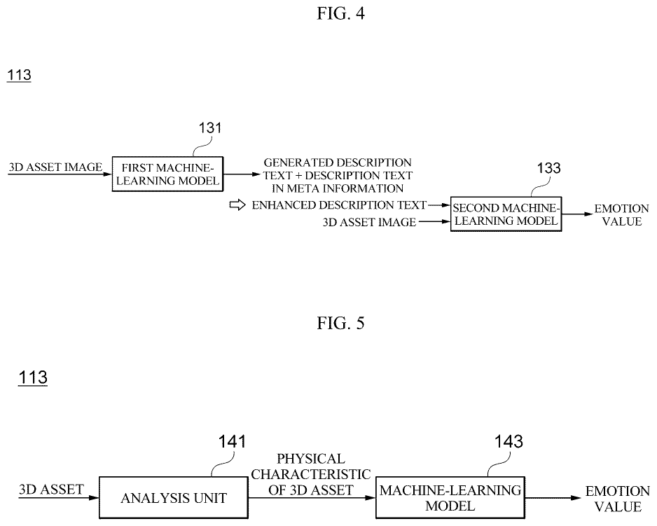

FIG. 4 shows the emotion value imputation module 113 for imputing an emotion value according a second embodiment of the present disclosure. Referring to FIG. 4, the emotion value imputation module 113 may include a first machine-learning model 131 and a second machine-learning model 133.

The first machine-learning model 131 may receive an input of a 3D asset image. The first machine-learning model 131 may be trained to generate description text for describing a 3D asset from the 3D asset image. The first machine-learning model 131 may adopt a large multimodal model (LMM).

The emotion value imputation module 113 may combine the description text generated by the first machine-learning model 131 and description text included in meta information about the 3D asset to generate enhanced description text. The emotion value imputation module 113 may input the 3D asset image and the enhanced description text to the second machine-learning model 133.

The second machine-learning model 133 may extract image embedding from the 3D asset image and text embedding from the enhanced description text. The second machine-learning model 133 may merge the image embedding and the text embedding to generate merged embedding. The second machine-learning model 133 may be trained to classify an emotion value for the 3D asset based on the merged embedding. The emotion value imputation module 113 may impart the emotion value output from the second machine-learning model 133 to the 3D asset.

### Third Embodiment

FIG. 5 shows the emotion value imputation module 113 for imputing an emotion value according a third embodiment of the present disclosure. Referring to FIG. 5, the emotion value imputation module 113 may include an analysis unit 141 and a machine-learning model 143.

The analysis unit 141 may analyze the physical characteristics of a 3D asset. Here, elements of the physical characteristics of the 3D asset may include the shape, the size, the texture, and the color. Such physical characteristics of the 3D asset may be used to infer an emotion value of the 3D asset. The 3D asset is digital content, and thus the physical characteristics mean the visually visible physical characteristics.

For example, when the shape of the 3D asset is an angular structure such as a rectangle or triangle, the 3D asset may cause emotion of strength. When the shape of the 3D asset is a smooth curve such as a circle, the 3D asset may cause emotion of stability. In addition, when the size of the 3D asset is large, the 3D asset may cause grandeur, and when the size of the 3D asset is small, the 3D asset may cause cuteness. In addition, when the texture of the 3D asset is coarse, the 3D asset may cause intensity, and when the texture of the 3D asset is smooth, the 3D asset may cause sweetness. In addition, when the color of the 3D asset is bluish, the 3D asset may cause coldness, and when the color of the 3D asset is reddish, the 3D asset may cause warmness.

The analysis unit 141 may quantify the physical characteristics of a 3D asset for each element. For example, the analysis unit 141 may quantify the shape of the 3D asset by an angle, a curvature, or the like. The analysis unit 141 may quantify the size of the 3D asset by means of a bounding box or the like. The analysis unit 141 may quantify the texture of the 3D asset by a value of roughness or smoothness. The analysis unit 141 may quantify the color of the 3D asset by an RGB pixel value. The quantified physical characteristics of the 3D asset may be matched and labeled with an emotion value.

The machine-learning model 143 may receive information about at least one physical characteristic of the 3D asset, and be trained to classify the emotion value of the 3D asset from the physical characteristic information about the 3D asset. Here, the machine-learning model 143 may be trained based on the input physical characteristic information about the 3D asset and the labeled emotion value of the physical characteristic information. In an embodiment, the machine-learning model 143 may be a decision tree model, but is not limited thereto. The emotion value imputation module 113 may impart the emotion value output from the machine-learning model 143 to the 3D asset.

### Fourth Embodiment

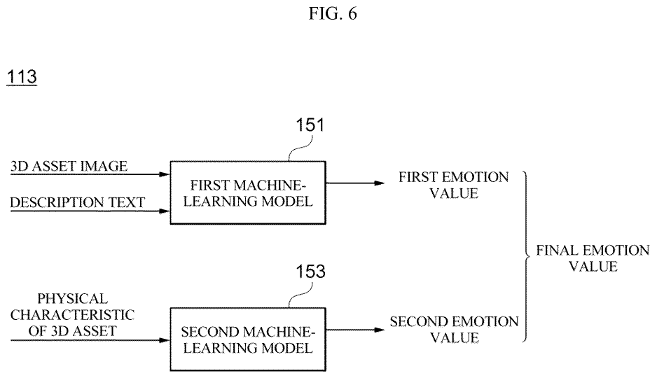

FIG. 6 shows the emotion value imputation module 113 for imputing an emotion value according a fourth embodiment of the present disclosure.

Referring to FIG. 6, the emotion value imputation module 113 may include a first machine-learning model 151 and a second machine-learning model 153.

The first machine-learning model 151 may receive an image and description text for a 3D asset to be trained to output a first emotion value for the 3D asset. In an embodiment, the first machine-learning model 151 may extract image embedding from the 3D asset, extract text embedding from the description text, and then merge the image embedding and the text embedding to generate merged embedding. The first machine-learning model 151 may classify the first emotion value for the 3D assets based on the merged embedding.

In another embodiment, the description text input to the first machine-learning model 151 may be description text that has been enhanced. Namely, the description text input to the first machine-learning model 151 may be enhanced by combining description text generated via a separate machine-learning model and description text in meta information.

The second machine-learning model 153 may receive information about the physical characteristics of the 3D asset to be trained to output a second emotion value for the 3D asset. The emotion value imputation model 113 may output a final emotion value for the 3D asset based on the first emotion value and the second emotion value. In an embodiment, the emotion value imputation model 113 may determine, as the final emotion value of the 3D asset, the average value of the first emotion value and the second emotion value, or the larger value between the first emotion value and the second emotion value.

Referring to FIG. 2 again, the search module 115 may search for a 3D asset corresponding to a search query of the user to provide the found 3D asset to the user. The search module 115 may analyze emotion desired by the user from the search query of the user, and extract, from the registered 3D assets, a 3D asset with the emotion value corresponding to the emotion desired by the user to provide the extracted 3D asset as the found result to the user.

In an embodiment, the search module 115 may include an AI chatbot 115a for interaction with the user. The AI chatbot 115a may be provided to perform chat with the user. The AI chatbot 115a may be provided to analyze questions and answers of the user via artificial intelligence and respond in correspondence to the analyzed result.

The search module 115 may recommend a 3D asset with a customized emotion value of the user based on user information and the information acquired through the chat with the user. In an embodiment, the search module 115 may determine an area to which the user belongs and the cultural background of the area based on the user information and the information acquired through the chat with the user (e.g., a language of the user, words used by the user, or the like).

The search module 115 may recommend, to the user, a 3D asset with an emotion value suitable to the user in consideration of the cultural background of the area to which the user belongs. In an embodiment, when the user is a Korean using Korean alphabet and performs a search using “ [symbol] ” as a keyword, the search module 115 may recommend to the user a 3D asset with a bright color and a smooth shape.

On the contrary, when the user is an American using English alphabet and equally performs a search using “happiness” as a keyword, the search module 115 may recommend to the user a 3D asset with an intense contrast color and highlighted fun elements. Namely, even in case of the same 3D asset, emotion accepted by a user may be differentiated according to the cultural characteristics, and thus a 3D asset with an emotion value suitable for the user may be recommended considering the cultural background of the user. Here, the emotion value of the 3D asset may be labeled and trained with the corresponding area (or the cultural characteristics of the area).

According to the disclosed embodiments, when it is checked whether an emotion value exists in meta information during registering of a 3D asset and it is determined that the emotion value do not exist, the emotion value is imputed based on a machine-learning technology and thus a user may search for a 3D asset with the emotion value desired by the user himself/herself.

A module in the specification may mean a functional and structural combination of hardware for performing the technical idea according to the present disclosure and software for driving the hardware. For example, the “module” may mean a logical unit of prescribed codes and hardware resources for executing the prescribed codes, but does not necessarily mean physically connected codes or one kind of hardware.

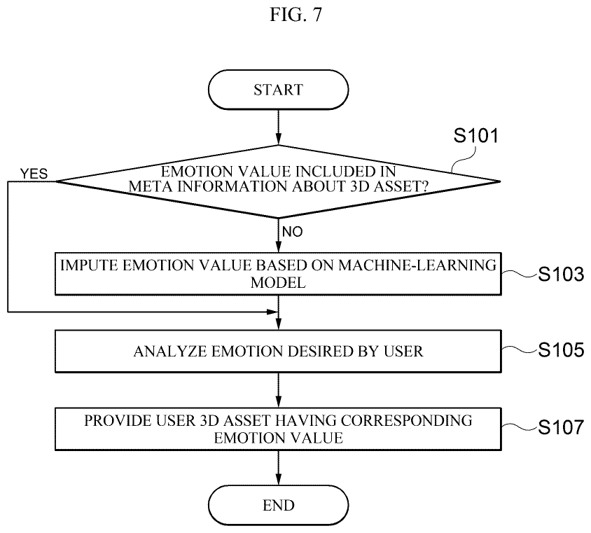

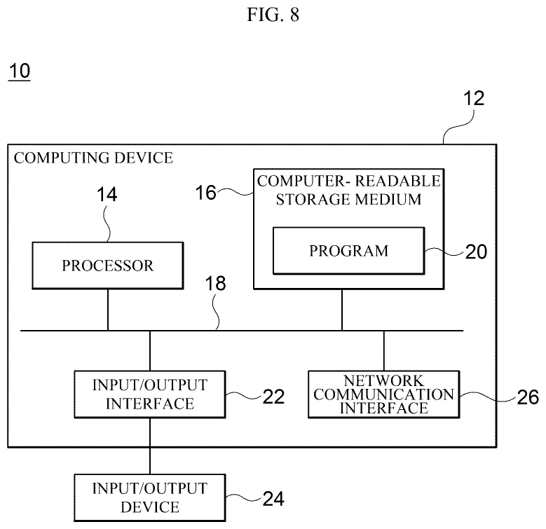

FIG. 7 shows a flowchart for explaining a 3D asset search method according to an embodiment of the present disclosure. In the shown flowchart, the method is divided into a plurality of steps, but at least some of the steps may be performed in a reverse order or in combination with other steps, or may be omitted or divided into sub-steps. One or more steps not shown in the drawing may also be additionally performed.

Referring to FIG. 7, when receiving a 3D asset registration request from the producer terminal 104, the service server 106 may check whether an emotion value is included in meta information about the 3D asset (S101).

As a check result in S101, when the emotion value is not included in the meta information about the 3D asset, the service server 106 may infer the emotion value of the 3D asset based on a machine-learning model to impute the emotion value (S103).

Then, the service server 106 may analyze emotion desired by the user through chat with the user. Then, the service server 106 may extract, from the registered 3D assets, a 3D asset with an emotion value corresponding to the emotion desired by the user to provide the user the 3D asset as the found result.

FIG. 8 is a block diagram illustratively describing a computing environment 10 including a computing device suitable for being used in example embodiments. In the shown embodiment, each component may have different functions and capabilities other than those described below, and include additional components other than those described below.

The illustrated computing environment 10 includes a computing device 12. In an embodiment, the computing device 12 may be the user terminal 102. In addition, the computing device 12 may be the producer terminal 104. In addition, the computing device 12 may be the service server 106.

The computing device 12 includes at least one processor 14, a computer-readable storage medium 16, and a communication bus 18. The processor 14 may cause the computing device 12 to operate according to the aforementioned example embodiments. For example, the processor 14 may execute one or more programs stored in the computer-readable storage medium 16. The one or more programs may include one or more computer-executable instructions, and when executed by the processor 14, the computer-executable instructions may cause the computing device 12 to perform operations according to the example embodiments.

The computer-readable storage medium 16 is configured to store the computer-executable instructions or program codes, program data and/or other suitable types of information. A program 20 stored in the computer-readable storage medium 16 includes a set of instructions executable by the processor 14. In one embodiment, the computer-readable storage medium 16 includes a memory (a volatile memory such as a random access memory, a nonvolatile memory, or a suitable combination thereof), one or more magnetic disk storage devices, optical disk storage devices, flash memory devices, or any other types of storage media that are accessible by the computing device 12 and capable of storing desired information, or a suitable combination thereof.

The communication bus 18 interconnects various other components, including the processor 14 and the computer-readable storage medium 16, of the computing device 12.

The computing device 12 may also include one or more input and output interfaces 22 and one or more network communication interfaces 26 that provide interfaces for one or more input and output devices 24. The input and output interfaces 22 and the network communication interfaces 26 are connected to the communication bus 18. The input and output device 24 may be connected to other components of the computing device 12 via the input and output interfaces 22. The example input and output device 24 may include a pointing device (such as a mouse or a trackpad), a keyboard, a touch input device (such as a touchpad or a touchscreen), a voice or sound input device, various types of sensor devices, and/or an input device such as an imaging device, and/or an output device such as a display device, a printer, a speaker, and/or a network card. The example input and output device 24 may be included inside the computing device 12 as one component of the computing device 12, and may be connected to the computing device 12 as a separate device from the computing device 12.

According to the disclosed embodiments, when it is checked whether an emotion value exists in meta information during registering of a 3D asset and it is determined that the emotion value do not exist, the emotion value is imputed based on a machine-learning technology and thus a user may search for a 3D asset with the emotion value desired by the user himself/herself.

Although the representative embodiments of the present disclosure have been described in detail above, those skilled in the art will appreciate that various modifications can be made to the above-described embodiments without departing from the scope of the present disclosure. Therefore, the scope of the present disclosure should not be limited to the described embodiments, but should be defined by the claims below and equivalents thereof.

What is claimed is:

1. A method performed by a computing device comprising one or more processors, and a memory configured to store one or more programs executed by the one or more processors, the method comprising:
receiving a 3D asset and a 3D asset registration request comprising meta information about the 3D asset;
checking whether an emotion value for the 3D asset is comprised in the meta information; and
imputing the emotion value for the 3D asset based on at least one machine-learning model when the emotion value for the 3D asset is not comprised in the meta information.

2. The method of claim 1, wherein the imputing of the emotion value comprises inputting an image of the 3D asset and description text for the 3D asset to the machine-learning model and training the machine-learning model to output an emotion value of the 3D asset.

3. The method of claim 2, wherein the training of the machine-learning model comprises:
causing the machine-learning model to extract image embedding from the image of the 3D asset;
causing the machine-learning model to extract text embedding from the description text;
causing the machine-learning model to merge the image embedding and the text embedding to generate merged embedding; and
causing the machine-learning model to output the emotion value of the 3D asset based on the merged embedding.

4. The method of claim 1, wherein the imputing of the emotion value comprises:
inputting the image of the 3D asset to a first machine-learning model to generate description text for describing the 3D asset;
combining the generated description text and description text comprised in the meta information to generate enhanced description text; and
inputting the image of the 3D asset and the enhanced description text to a second machine-learning model to cause the emotion value for the 3D asset to be output.

5. The method of claim 4, wherein the causing of the emotion value for the 3D asset to be output comprises:
causing the second machine-learning model to extract image embedding from the image of the 3D asset;
causing the second machine-learning model to extract text embedding from the enhanced description text;
causing the second machine-learning model to merge the image embedding and the text embedding to generate merged embedding; and
causing the second machine-learning model to output the emotion value for the 3D asset based on the merged embedding.

6. The method of claim 1, wherein the imputing of the emotion value comprises:
analyzing physical characteristics comprising at least one of a shape, a size, texture, or a color of the 3D asset; and
inputting information about the at least one physical characteristic of the 3D asset to the second machine-learning model to cause the emotion value for the 3D asset to be output.

7. The method of claim 6, wherein the imputing of the emotion value comprises:
quantifying the physical characteristic of the 3D asset; and
matching a quantified value of the physical characteristic of the 3D asset with an emotion value corresponding thereto to perform labeling.

8. The method of claim 1, wherein the imputing of the emotion value comprises:
inputting an image of the 3D asset and description text for the 3D asset to a first machine-learning model to output a first emotion value for the 3D asset;
inputting information about physical characteristics of the 3D asset to a second machine-learning model and causing a second emotion value for the 3D asset to be output; and
outputting a final emotion value for the 3D asset based on the first emotion value and the second emotion value.

9. The method of claim 1, further comprising:
analyzing emotion desired by a user in a search query of the user; and
extracting, from registered 3D assets, a 3D asset with an emotion value corresponding to the emotion desired by the user to provide the 3D asset to the user.

10. The method of claim 1, further comprising recommending a 3D asset with an emotion value suitable to a user based on at least one of user information about the user who performs chat with an artificial intelligence (AI) chatbot or information acquired through the chat with the user.

11. The method of claim 10, wherein the recommending of the 3D asset comprises:
identifying cultural background of an area to which the user belongs based on at least one of the user information or the information acquired through the chat with the user; and
recommending to the user the 3D asset with an emotion value suitable for the user in consideration of the cultural background of the user.

12. A computing device comprising:
one or more processors;
a memory; and
one or more programs,
wherein the one or more programs are stored in the memory and executed by the one or more processors, and
wherein the one or more programs comprise:
an instruction for receiving a 3D asset and a 3D asset registration request comprising meta information about the 3D asset;
an instruction for checking whether an emotion value for the 3D asset is comprised in the meta information; and
an instruction for imputing the emotion value for the 3D asset based on at least one machine-learning model when the emotion value for the 3D asset is not comprised in the meta information.

13. The computing device of claim 12, wherein the instruction for imputing the emotion value comprises an instruction for inputting an image of the 3D asset and description text for the 3D asset to the machine-learning model and training the machine-learning model to output an emotion value of the 3D asset.

14. The method of claim 12, wherein the instruction for imputing the emotion value comprises:
an instruction for inputting an image of the 3D asset to a first machine-learning model to generate description text for describing the 3D asset;
an instruction for combining the generated description text and description text comprised in the meta information to generate enhanced description text; and
an instruction for inputting the image of the 3D asset and the enhanced description text to a second machine-learning model and causing an emotion value for the 3D asset to be output.

15. The computing device of claim 12, wherein the instruction for imputing the emotion value comprises:
an instruction for analyzing physical characteristics comprising at least one of a shape, a size, texture, or a color of the 3D asset; and
an instruction for inputting information about one or more of the physical characteristic of the 3D asset to a machine-learning model to cause an emotion value for the 3D asset to be output.

16. The computing device of claim 12, wherein the instruction for imputing the emotion value comprises:
an instruction for inputting an image of the 3D asset and description text for the 3D asset to a first machine-learning model to output a first emotion value for the 3D asset;
an instruction for inputting information about physical characteristics of the 3D asset to a second machine-learning model to cause a second emotion value for the 3D asset to be output; and
an instruction for outputting a final emotion value for the 3D asset based on the first emotion value and the second emotion value.

17. The computing device of claim 12, wherein the one or more programs further comprise:
an instruction for analyzing emotion desired by a user in a search query of the user; and
an instruction for extracting, from registered 3D assets, a 3D asset with an emotion value corresponding to the emotion desired by the user to provide the 3D asset to the user.

18. The computing device of claim 12, wherein the one or more programs further comprise an instruction for recommending a 3D asset with an emotion value suitable to a user, who performs chat with an AI chatbot, based on at least one of user information about the user and information acquired through the chat with the user.

19. The computing device of claim 12, wherein the instruction for recommending the 3D asset comprises:
an instruction for identifying cultural background of an area to which a user belongs based on at least one of user information and information acquired through chat with the user; and
an instruction for recommending to the user a 3D asset with an emotion value suitable for the user in consideration of the cultural background of the user.

20. A computer program stored in a non-transitory computer readable storage medium, the computer program comprising one or more instructions, wherein, when executed by a computing device comprising one or more processors, the instructions cause the computing device to:
receive a 3D asset and a 3D asset registration request comprising meta information about the 3D asset;
determine whether an emotion value for the 3D asset is comprised in the meta information; and
impute the emotion value for the 3D asset based on at least one machine-learning model when the emotion value for the 3D asset is not comprised in the meta information.
